(19) United States
(12) Patent Application Publication
(10) Pub. No.: US 2020/0332814 A1
(43) Pub. Date: Oct. 22, 2020

(54) LOCKING MECHANISM OF MOVABLE EQUIPMENT AND MOVABLE EQUIPMENT

(71) Applicant: JIANGSU JELT LIFTING SYSTEM CO., LTD., Changzhou City (CN)

(72) Inventors: Shengrong Tao, Changzhou City (CN); Xiaogang Li, Changzhou City (CN)

(21) Appl. No.: 16/834,876

(22) Filed: Mar. 30, 2020

(30) Foreign Application Priority Data
Apr. 16, 2019 (CN) 201920509600.9

(51) Int. Cl. F16B 5/06

(52) U.S. Cl. CPC F16B 5/06

(57) ABSTRACT

The present utility relates a locking mechanism of movable equipment, including: a first torsion spring, enclasping the movable equipment; a first connection assembly, wherein one end of the first torsion spring is fixed with the first connection assembly; and a switch, fixed with the other end of the first torsion spring, wherein when the switch is rotated, the first torsion spring is twisted, and a diameter of an inner hole of the first torsion spring is increased to release the locking of the movable equipment. The present utility model is advantageous for reducing the production cost of the movable equipment.

### TECHNICAL FIELD

The present utility model relates to a locking mechanism of movable equipment and movable equipment.

### BACKGROUND ART

As a daily necessity, tables are commonly used in life, work and school. A general table is usually formed by fixedly connecting a tabletop with table legs, and the lengths of the table legs are also fixed, so that the height of the entire tabletop is fixed and unadjustable. With different application environments and application needs of different groups of people, there are higher and higher requirements for the height diversity, automation and comfort of a table.

Air springs have been adopted to serve as table legs of a lifting table to support the tabletop. A control assembly for controlling the air springs to be twisted or untwisted is mounted on the lower surface of the lifting table. The control assembly is connected with a cable connection member on a connection assembly (the cable connection member is hinged to the connection assembly) through a component such as a cable. The other end of the cable connection member abuts with switches of the air springs. When the table needs to rise up or fall down, a user controls the control assembly to transmit power through the cable to enable the cable connection member to rotate, so that the switches of the air springs are turned on to allow the air springs to rise up or fall down according to the intention of the user.

The air springs used in the lifting table in the prior art are all self-locked air springs. That is, when the air springs need to be operated, the user controls the control assembly to transmit the power through the cable to enable the cable connection member to rotate, so that the switches inside the air springs are turned on to allow the air springs to rise up or fall down according to the intention of the user. The switch structure inside such an air spring is relatively complicated, so that the production cost of the air spring is high; and furthermore, the switch arranged inside the air spring needs to occupy part of the space, so that the stroke of the air spring is short at least.

### SUMMARY OF THE INVENTION

The objective of the present utility model is to provide a locking mechanism of movable equipment and movable equipment. The present utility model is advantageous for reducing the production cost of the movable equipment.

The technical solution for achieving the above objective is as follows:

a locking mechanism of movable equipment, including:

a first torsion spring, enclasping the movable equipment;

a first connection assembly, wherein one end of the first torsion spring is fixed with the first connection assembly; and

a switch, fixed with the other end of the first torsion spring, wherein when the switch is rotated, the first torsion spring is twisted, and a diameter of an inner hole of the first torsion spring is increased to release the locking of the movable equipment.

Movable equipment, provided with the locking mechanism according to any one of claims 1 to 5.

When the present utility model works, an unlocking mechanism drives the locking mechanism to enable the switch in the locking mechanism to rotate and then enable the first torsion spring to be twisted, and the diameter of the inner hole of the first torsion spring is increased, so as to release the locking of the movable equipment. After the locking of a power output portion is released, the movable equipment may move freely, so as to drive a component connected therewith to move. In the present utility model, the movable equipment is locked through the locking mechanism, so that the movable equipment is convenient to control. Furthermore, since the movable equipment that is maintained in an on state all the time is used, no switch needs to be arranged in the movable equipment. Therefore, the structure of the movable equipment is simplified, and the manufacturing cost of the movable equipment is lower than the cost of existing movable equipment.

### BRIEF DESCRIPTION OF THE DRAWINGS

FIG. 1 is an assembling schematic diagram of movable equipment and a locking mechanism in the present utility model;

FIG. 2 is a cross-sectional view on the basis of FIG. 1 after part of accessories are hidden; and

FIG. 3 is a schematic diagram on the basis of FIG. 1 after part of accessories are hidden.

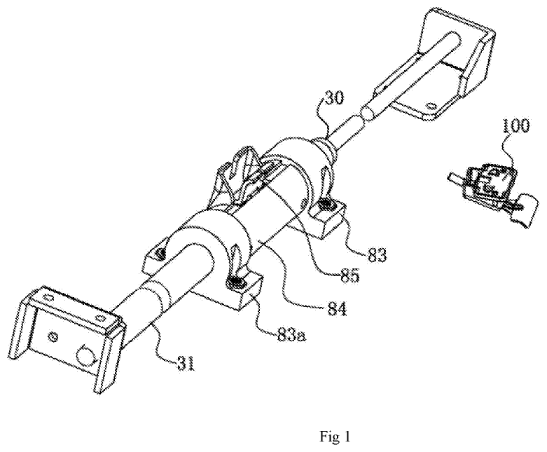

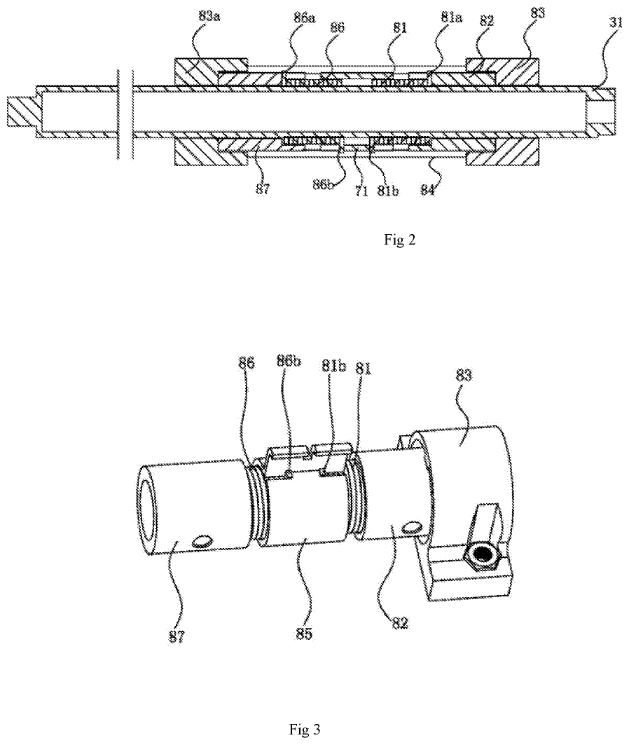

### REFERENCE NUMERALS IN FIGS. 1 TO 3 ARE AS FOLLOWS

30: movable equipment
80: locking mechanism; 81: first torsion spring; 81a: one end; 81b: the other end; 82: first sleeve; 83: body; 83a: second fixed seat; 84: casing; 85: switch; 86: second torsion spring; 86a: one end; 86b: the other end; 87: second sleeve;
100: unlocking mechanism.

### DETAILED DESCRIPTION OF THE INVENTION

As shown in FIGS. 1 to 3, movable equipment 30 is a linear mover or a rotary mover. In the present embodiment, the movable equipment 30 is preferably the linear mover. The linear mover is an air spring that is maintained in an on state all the time. A locking mechanism 80 is mounted on a power output portion 31 of the movable equipment 30. The power output portion 31 may be a cylinder portion of the movable equipment 30 or a piston rod portion of the movable equipment 30. In the present embodiment, the power output portion 31 is preferably the cylinder portion of the movable equipment 30, that is, the cylinder portion is a movable portion, while the piston rod portion is fixed. The locking mechanism 80 limits the displacement of the power output portion 31 of the movable equipment. The locking mechanism 80 includes: a first torsion spring 81, a first connection assembly and a switch 85. The first torsion spring 81 enclasps the power output portion 31 of the movable equipment 30.

As shown in FIGS. 1 to 3, one end 81a of the first torsion spring 81 is fixed with the first connection assembly. The first connection assembly includes a first sleeve 82 and a first fixed seat. The first sleeve 82 is arranged on the power output portion 31 of the movable equipment 30 in a sleeving manner. One end of the first sleeve 82 is provided with a first opening. One end 81a of the first torsion spring 81 is clamped in the first opening. The first fixed seat is fixedly connected with the first sleeve 82. The first fixed seat 83 is connected with a fixing member (not shown in the figures). The first fixed seat includes a body 83 and a casing 84. The body 83 is fixed with the casing 84. The first sleeve 82 is fixed with the casing 84. The first fixed seat may also include only the body 83, and the body 83 is directly fixed with the first sleeve 82.

As shown in FIGS. 1 to 3, the switch 85 is fixed with the other end 81b of the first torsion spring 81. When the switch 85 is rotated, the first torsion spring 81 is twisted, and a diameter of an inner hole of the first torsion spring 81 is increased to release the locking of the power output portion 31 of the movable equipment 30.

As shown in FIGS. 1 to 3, the locking mechanism 80 further includes a second torsion spring 86 and a second connection assembly. The second torsion spring 86 enclasps the power output portion 31 of the movable equipment 30. One end 86a of the second torsion spring 86 is fixed with the second connection assembly, and the other end 86b of the second torsion spring 86 is fixed with the switch 85. When the switch 85 is rotated, the second torsion spring 86 is twisted, and a diameter of an inner hole of the second torsion spring 86 is increased to release the locking of the power output portion 31 of the movable equipment 30. The first torsion spring 81 and the second torsion spring 86 are oppositely twisted, so that the first torsion spring 81 and the second torsion spring 86 may be simultaneously twisted by the same switch 85, and may be simultaneously reset.

As shown in FIGS. 1 to 3, the second connection assembly includes a second sleeve 87 and a second fixed seat 83a. The second sleeve 87 is arranged on the power output portion 31 of the movable equipment 30 in a sleeving manner. One end of the second sleeve 87 is provided with a second opening. One end of the second torsion spring 86 is clamped in the second opening. The second fixed seat 83a is fixedly connected with the second sleeve 87. The second fixed seat 83a is connected with a fixing member (not shown in the figures). The second fixed seat 83a is arranged on the casing 84 in a sleeving manner and fixed with the casing 84.

As shown in FIGS. 1 to 3, an unlocking mechanism 100 drives the locking mechanism 80 to be separated from the power output portion 31 of the movable equipment 30 in a cooperative manner, and the unlocking mechanism 100 is connected with the locking mechanism 80. The unlocking mechanism 100 includes a pressure plate mechanism and a cable. The pressure plate mechanism is connected with one end of the cable. The other end of the pressure plate mechanism is connected with the switch 85. The pressure plate mechanism works to drive the cable to move, and the cable drives the switch 85 to rotate, thereby driving the first torsion spring 81 and the second torsion spring 86 to be twisted to release the locking of the power output portion 31 of the movable equipment 30.

The present utility model is not limited to the above embodiment. For example, when the movable equipment 30 is the linear mover, the linear mover may also be an air cylinder, a hydraulic cylinder and the like. As the rotary mover, the movable equipment 30 may be, for example, a ring-like component or a gear, and at the moment, the locking mechanism may be of an arc shape.

1. A locking mechanism of movable equipment, comprising:
a first torsion spring, enclasping the movable equipment;
a first connection assembly, wherein one end of the first torsion spring is fixed with the first connection assembly; and
a switch, fixed with the other end of the first torsion spring, wherein when the switch is rotated, the first torsion spring is twisted, and a diameter of an inner hole of the first torsion spring is increased to release the locking of the movable equipment.

2. The locking mechanism according to claim 1, further comprising:
a second torsion spring, enclasping the movable equipment; and
a second connection assembly, wherein one end of the second torsion spring is fixed with the second connection assembly;
the other end of the second torsion spring is fixed with the switch; when the switch is rotated, the second torsion spring is twisted, and a diameter of an inner hole of the second torsion spring is increased to release the locking of the movable equipment.

3. The locking mechanism according to claim 1, wherein the first connection assembly comprises:
a first sleeve, arranged on the movable equipment in a sleeving manner; and
a first fixed seat, wherein the first fixed seat is fixedly connected with the first sleeve.

4. The locking mechanism according to claim 3, wherein the first fixed seat comprises a body and a casing; the body is fixed with the casing; and the first sleeve is fixed with the casing.

5. The locking mechanism according to claim 2, wherein the second connection assembly comprises:
a second sleeve, arranged on the movable equipment in a sleeving manner; and
a second fixed seat, wherein the second fixed seat is fixedly connected with the second sleeve.

6. The locking mechanism according to claim 2, wherein the first torsion spring and the second torsion spring are oppositely twisted.

7. The locking mechanism according to claim 1, wherein the movable equipment is a linear mover or a rotary mover.

8. Movable equipment, being provided with the locking mechanism according to claim 7.

9. The movable equipment according to claim 8, wherein the movable equipment is an air spring maintained in an on state.

10. The locking mechanism according to claim 7, further comprising:
a second torsion spring, enclasping the movable equipment; and
a second connection assembly, wherein one end of the second torsion spring is fixed with the second connection assembly;
the other end of the second torsion spring is fixed with the switch; when the switch is rotated, the second torsion spring is twisted, and a diameter of an inner hole of the second torsion spring is increased to release the locking of the movable equipment.

11. The locking mechanism according to claim 7, wherein the first connection assembly comprises:
a first sleeve, arranged on the movable equipment in a sleeving manner; and
a first fixed seat, wherein the first fixed seat is fixedly connected with the first sleeve.

12. The locking mechanism according to claim 11, wherein the first fixed seat comprises a body and a casing; the body is fixed with the casing; and the first sleeve is fixed with the casing.

13. The locking mechanism according to claim 10, wherein the second connection assembly comprises:
a second sleeve, arranged on the movable equipment in a sleeving manner; and
a second fixed seat, wherein the second fixed seat is fixedly connected with the second sleeve.

14. The locking mechanism according to claim 10, wherein the first torsion spring and the second torsion spring are oppositely twisted.

15. The movable equipment according to claim 8, further comprising:
a second torsion spring, enclasping the movable equipment; and
a second connection assembly, wherein one end of the second torsion spring is fixed with the second connection assembly;
the other end of the second torsion spring is fixed with the switch; when the switch is rotated, the second torsion spring is twisted, and a diameter of an inner hole of the second torsion spring is increased to release the locking of the movable equipment.

16. The movable equipment according to claim 8, wherein the first connection assembly comprises:
a first sleeve, arranged on the movable equipment in a sleeving manner; and
a first fixed seat, wherein the first fixed seat is fixedly connected with the first sleeve.

17. The movable equipment according to claim 16, wherein the first fixed seat comprises a body and a casing; the body is fixed with the casing; and the first sleeve is fixed with the casing.

18. The movable equipment according to claim 15, wherein the second connection assembly comprises:
a second sleeve, arranged on the movable equipment in a sleeving manner; and
a second fixed seat, wherein the second fixed seat is fixedly connected with the second sleeve.

19. The movable equipment according to claim 15, wherein the first torsion spring and the second torsion spring are oppositely twisted.
